(19) United States
(12) Patent Application Publication
(10) Pub. No.: US 2016/0247461 A1
(43) Pub. Date: Aug. 25, 2016

(54) LIQUID CRYSTAL DRIVE APPARATUS, LIQUID CRYSTAL DISPLAY APPARATUS AND STORAGE MEDIUM STORING LIQUID CRYSTAL DRIVING PROGRAM

(71) Applicant: CANON KABUSHIKI KAISHA, Tokyo (JP)

(72) Inventor: Michihisa Yanagi, Utsunomiya-shi (JP)

(21) Appl. No.: 15/042,649

(22) Filed: Feb. 12, 2016

(30) Foreign Application Priority Data
Feb. 20, 2015 (JP) 2015-031216

(51) Int. Cl. G09G 3/34; G09G 3/36

(52) U.S. Cl. CPC G09G 3/3413; G09G 3/36; G09G 2310/08

(57) ABSTRACT

The liquid crystal drive apparatus drives a liquid crystal display element. The apparatus includes a tone setter to set a tone value for each pixel of the liquid crystal display element on a basis of an input image signal, and a disclination determiner to determine, by using the tone value for a specific pixel of the liquid crystal display element set on the basis of the input image signal, whether disclination is generated in the specific pixel. When a determination that the disclination is generated is made, the tone setter periodically changes the tone value for the specific pixel, by using a tone value for a peripheral pixel located in a periphery of the specific pixel and the tone value set on the basis of the input image signal.

### BACKGROUND OF THE INVENTION

1. Field of the Invention

The present invention relates to a technique of reducing image quality degradation due to disclination generated in a liquid crystal display element.

2. Description of the Related Art

Liquid crystal display elements involve, as a problem, a disturbance of orientations of liquid crystal molecules, which is called “disclination”. The disclination is caused by a horizontal electric field generated between mutually adjacent pixels to which mutually different drive voltages are applied. Japanese Patent Laid-Open Nos. 2012-203052 and 2009-237366 disclose methods of reducing image quality degradation of a displayed image due to the disclination. The method disclosed in Japanese Patent Laid-Open No. 2012-203052 produces a feature amount based on a number of pixel pairs of a target pixel and its peripheral pixel satisfying a predetermined correspondence relation between their tone values. The method performs, when the feature amount is larger than a threshold, a correction (reduction) of a dynamic range of tone values of an input image signal. On the other hand, the method disclosed in Japanese Patent Laid-Open No. 2009-237366 performs a correction of a brightness of a liquid crystal pixel (disclination pixel) which is changed due to the disclination so as to make the changed brightness close to its original brightness, by changing a drive voltage applied to the disclination pixel.

However, the method disclosed in Japanese Patent Laid-Open No. 2012-203052 performs the correction also on other pixels than pixels in which the image quality degradation due to the disclination is generated, and therefore the correction itself may deteriorate image quality of the displayed image. Specifically, a brightness of a low-reflectance (or low-transmittance) portion of the liquid crystal display element is raised and a brightness of a high-reflectance (or high-transmittance) portion thereof is lowered, which decreases a contrast of the displayed image.

In contrast, the method disclosed in Japanese Patent Laid-Open No. 2009-237366 performs the correction only on the disclination pixel. However, in a high brightness area where the image quality degradation (lowered brightness) due to the disclination is generated, the drive voltage applied to the disclination pixel cannot be increased because of an upper limit value of the drive voltage. Therefore, a sufficient correction cannot be performed. Furthermore, the method disclosed in Japanese Patent Laid-Open No. 2009-237366 adds a voltage for the correction to the drive voltage applied to the disclination pixel, which may generates new disclination.

### SUMMARY OF THE INVENTION

The present invention provides a liquid crystal drive apparatus and a liquid crystal display apparatus each capable of performing a process to effectively reduce image quality degradation due to disclination.

The present invention provides as an aspect thereof a liquid crystal drive apparatus configured to drive a liquid crystal display element. The apparatus includes a tone setter configured to set a tone value for each pixel of the liquid crystal display element on a basis of an input image signal, and a disclination determiner configured to determine, by using the tone value for a specific pixel of the liquid crystal display element set on the basis of the input image signal, whether disclination is generated in the specific pixel. The tone setter is configured to, when a determination that the disclination is generated is made, periodically change the tone value for the specific pixel, by using a tone value for a peripheral pixel located in a periphery of the specific pixel and the tone value set on the basis of the input image signal.

The present invention provides as another aspect thereof a liquid crystal display apparatus includes a liquid crystal display element and the above liquid crystal drive apparatus.

The present invention provides as still another aspect thereof a non-transitory computer-readable storage medium storing a liquid crystal drive program to cause a computer to operate as the above a liquid crystal display apparatus.

Further features and aspects of the present invention will become apparent from the following description of exemplary embodiments with reference to the attached drawings.

### BRIEF DESCRIPTION OF THE DRAWINGS

FIG. 1 is a block diagram showing a configuration of a projector that is Embodiment 1 of the present invention.

FIGS. 2A and 2B are flowcharts showing a disclination estimation process and a liquid crystal drive process in Embodiment 1.

FIG. 3 shows a tone value shift table used in the liquid crystal drive process in Embodiment 1.

FIG. 4 shows a tone value shift in the liquid crystal drive process in Embodiment 1.

FIG. 5 shows a tone value shift in a liquid crystal drive process in Embodiment 2 of the present invention.

FIG. 6 is a flowchart showing a liquid crystal drive process in Embodiment 3 of the present invention.

### DESCRIPTION OF THE EMBODIMENTS

Exemplary embodiments of the present invention will be described below with reference to the accompanied drawings.

### Embodiment 1

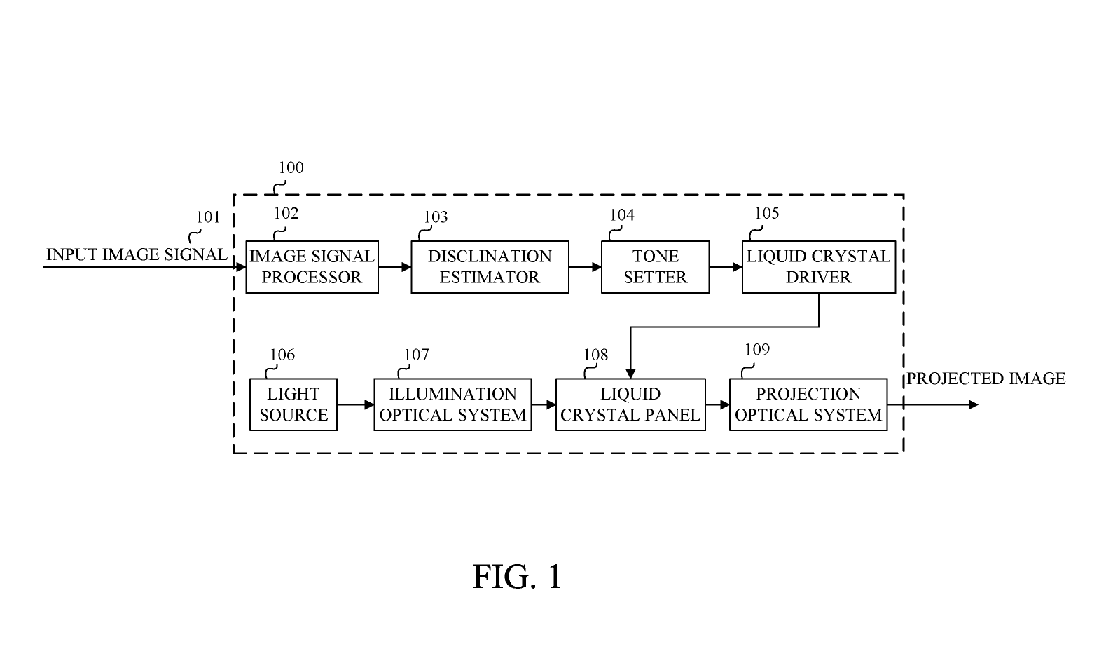

FIG. 1 shows a configuration of a liquid crystal projector 100 as a liquid crystal display apparatus that is a first embodiment (Embodiment 1) of the present invention. Although this embodiment and other embodiments (described later) will describe liquid crystal projectors, alternative embodiments of the present invention include other liquid crystal display apparatuses than the liquid crystal projector, such as a direct-view liquid crystal monitor.

The liquid crystal projector (hereinafter simply referred to as “a projector”) 100 receives an input image signal 101 as a video signal that is input from a video source (not shown). An image signal processor 102 performs a resolution conversion of the input image signal 101 depending on a resolution of a liquid crystal panel 108 described later.

The image signal processor 102 further converts the input image signal after the resolution conversion into a tone value (hereinafter referred to as “an input tone value”) and a synchronizing signal to drive the liquid crystal panel 108 as a liquid crystal display element, depending on colors and a gradation property which are achieved in a projected image (displayed image) and on a spatial filter characteristic. The input tone value and the synchronizing signal are input to a disclination estimator 103.

The disclination estimator 103 performs a disclination estimation process to estimate, on a basis of the input tone value, generation of disclination in the liquid crystal panel 108. A specific example of the disclination estimation process will be described later.

A tone setter 104 outputs, for a pixel of the liquid crystal panel 108 in which the generation of disclination is not estimated by the disclination estimator 103, the input tone value from the image signal processor 102 without change as a drive tone value to a liquid crystal driver 105. The tone setter 104 performs, for a pixel (hereinafter referred to as “a specific pixel”) in which the generation of disclination is estimated by the disclination estimator 103, an image quality degradation reduction process to reduce image quality degradation due to the disclination on its drive tone value. The tone setter 104 outputs the drive tone value subjected to the image quality degradation reduction process to the liquid crystal driver 105. A specific example of the image quality degradation reduction process will be described later. The drive tone value equal to the input tone value (that is, the drive tone value not subjected to the image quality degradation reduction process) is a drive tone value set on the basis of the input tone value, and is hereinafter referred to as “a drive tone value corresponding to the input tone value”.

The liquid crystal driver 105 converts the drive tone value and the synchronizing signal that are input from the tone setter 104 into a drive signal for driving the liquid crystal panel 108. The liquid crystal driver 105 can drive an analog liquid crystal panel and a digital liquid crystal panel. When driving the analog liquid crystal panel, the liquid crystal driver 105 supplies a voltage applied to a pixel electrode of the panel 108 directly or via an amplifier. On the other hand, when driving the digital liquid crystal panel, the liquid crystal driver 105 converts the drive tone value into a combination (drive pattern) of binary signals of H and L and performs pulse width modulation of a voltage applied to a pixel electrode depending on this drive pattern. Although it is ideal that a pulse signal proportional to the number of H in the drive pattern is applied to the pixel electrode, the pulse signal often dulls in reality due to a response characteristic of the liquid crystal panel 108 or its peripheral circuit, which is not ideal. In such a case, a predetermined relation between the tone values of mutually adjacent two pixels increases a possibility of generation of the disclination in at least one pixel thereof. This embodiment provides, especially in such a case, an effect of reducing the image quality degradation due to the disclination.

The image signal processor 102, the disclination estimator (disclination determiner) 103, the tone setter 104 and the liquid crystal driver 105 constitute a liquid crystal drive apparatus built in the projector 100.

As a light source 106, a discharge arc tube such as a high-pressure mercury lamp, an LED or a laser is used. Light from the light source 106 is introduced through an illumination optical system 107 to the liquid crystal panel 108, as an illumination light that uniformly illuminates the liquid crystal panel 108. The liquid crystal panel 108 driven by the liquid crystal driver 105 modulates the illumination light at each pixel to produce an image light. Although not shown in the figure, an actual projector includes three liquid crystal panels 108 for three colors of RGB (or CMY). The image light subjected to the modulation by the liquid crystal panel 108 is projected through a projection optical system 109 onto a projection surface (not shown) such as a screen.

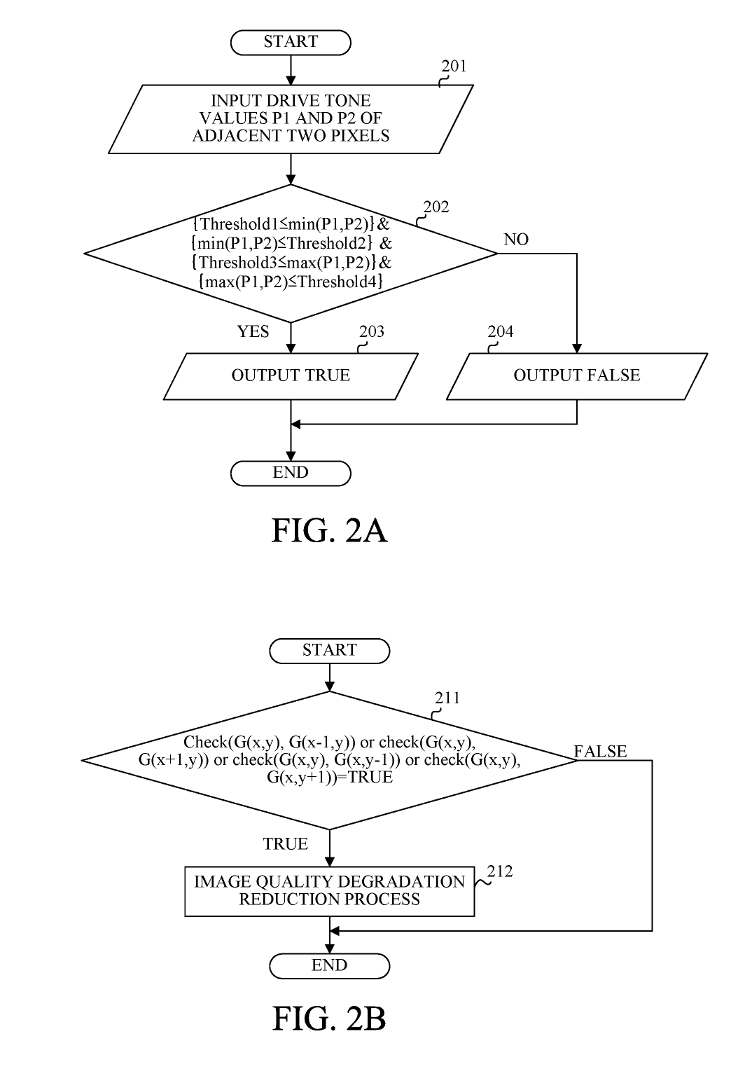

Next, description will be made of the disclination estimation process for the liquid crystal panel 108 with reference to a flowchart shown in FIG. 2A. This process is performed by the disclination estimator 103 included in the liquid crystal drive apparatus constituted as a computer such as a CPU or an IC, according to a liquid crystal drive program as a computer program. In addition, this process is performed as “check” at step 211 that is part of a liquid crystal drive process shown in FIG. 2B and described later.

At step 201, the disclination estimator 103 reads input tone values P1 and P2 input from the image signal processor 102 for mutually adjacent two pixels (hereinafter simply referred to as “adjacent two pixels”).

At step 202, the disclination estimator 103 determines whether or not the input tone values P1 and P2 for the adjacent two pixels read at step 201 meet a condition under which the disclination is generated. Specifically, the disclination estimator 103 determines whether or not the input tone values P1 and P2 are respectively included in two predetermined ranges defined with mutually different upper limits and mutually different lower limits. More specifically, the disclination estimator 103 determines whether or not a lower one of the input tone values P1 and P2 is within a first range whose lower limit is Threshold 1 and whose upper limit is Threshold 2 and a higher one of the input tone values P1 and P2 is within a second range whose lower limit is Threshold 3 (>Threshold 1) and whose upper limit is Threshold 4 (>Threshold 2).

If this condition is met, the disclination estimator 103 estimates that the disclination is generated in at least one pixel (specific pixel) of these adjacent two pixels and then proceeds to step 203. If the condition is not met, the disclination estimator 103 estimates that the disclination is not generated and then proceeds to step 204.

The above-described condition means that a difference between the input tone values P1 and P2 for the adjacent two pixels is large enough to generate the disclination, but is not too large. This condition is based on the following two reasons. The first reason is because a case where the difference of the input tone values of the adjacent two pixels is too large corresponds to a case where a high contrast image including characters is displayed. In such a case, it is desirable to prevent the image quality degradation reduction process described later from being performed to avoid a decrease of the contrast of the high contrast image.

The second reason is because the image quality degradation due to the disclination typically causes a contour-like colored portion in a gradation area whose tone value gradually changes. Thus, it is desirable to perform the image quality degradation reduction process only on pixels (specific pixels) included in such a contour-like colored portion.

At step 203, the disclination estimator 103 outputs “TRUE” showing that the disclination is generated. At step 204, the disclination estimator 103 outputs “FALSE” showing that the disclination is not generated. Then, the disclination estimator 103 ends the process.

The condition for the estimation of the generation of disclination described at step 202 is merely an example, and other condition may be used for the estimation. For example, a condition that the difference between the input tone values P1 and P2 is larger than a predetermined value may be used for the estimation of the generation of disclination.

Next, description will be made of the liquid crystal drive process performed according to the liquid crystal drive program mentioned above by the disclination estimator 103 and the tone setter 104 by using a flowchart shown in FIG. 2B. The following description is made of a case where the liquid crystal drive process is performed on the liquid crystal panel for G among the three liquid crystal panels 108 for RGB.

At step 210, the tone setter 104 selects, from the liquid crystal panel 108, four sets of adjacent two pixels which include a target pixel G(x, y) and one of G(x−1, y), G(x+1, y), G(x, y−1) and G (x, y+1) adjacent in upper, lower, left and right directions to the target pixel. Then, the disclination estimator 103 performs, on each of the four sets of adjacent two pixels, the disclination estimation process (for example, check (G (x, y), G (x−1, y))) described by using the flowchart of FIG. 2A. This process is performed on all pixels of the liquid crystal panel 108. That is, all sets of adjacent two pixels are selected from the all the pixels of the liquid crystal panel 108, and the disclination estimation process is performed on the respective sets of adjacent two pixels.

There are a case where no pixel exists further outside than outermost pixels of an effective display area of the liquid crystal panel 108 and a case where pixels driven in a black display state (black display pixels) exists further outside than the outermost pixels. In the latter case, the disclination estimation process may be performed on adjacent two pixels including the black display pixel. In the former case, the disclination estimation process may be performed by regarding such a black display pixel as existing further outside than the outermost pixels.

When TRUE is output as a result of the disclination estimation process at this step, the tone setter 104 proceeds to step 212 to perform the image quality degradation reduction process on the above-mentioned specific pixel. Then, the tone setter 104 outputs a drive tone value subjected to the image quality degradation reduction process for the specific pixel to the liquid crystal driver 105. On the other hand, when FALSE is output as a result of the disclination estimation process, the tone setter 104 outputs, without performing the image quality degradation reduction process for the specific pixel, a drive tone value corresponding to the input tone value from the image signal processor 102 to the liquid crystal driver 105. Thereafter, the tone setter 104 (and the disclination estimator 103) ends this process.

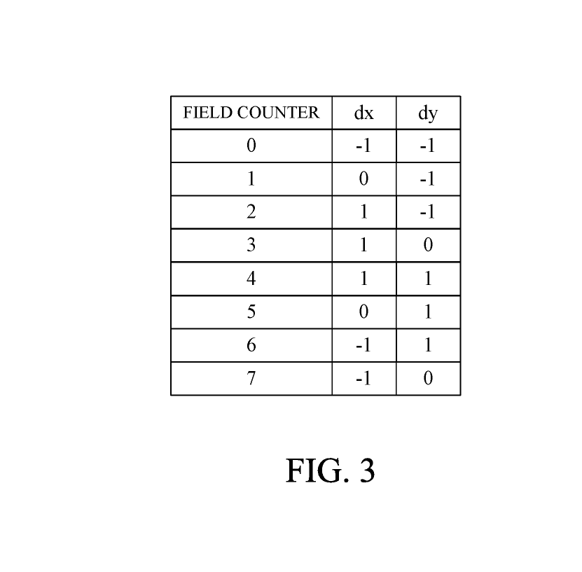

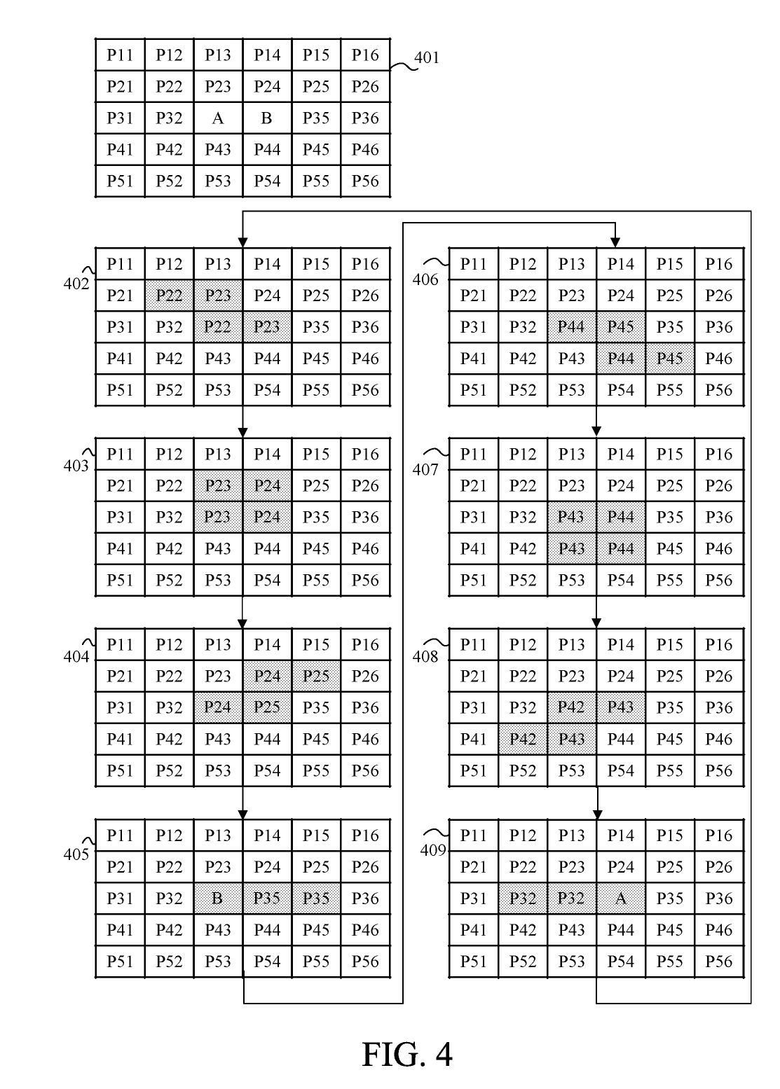

Next, description will be made of specific examples of the image quality degradation reduction process by using FIGS. 3 and 4. The tone setter 104 periodically changes the drive tone value for the specific pixel, by using the drive tone value for a peripheral pixel located in a periphery of the specific pixel and the drive tone value set on the basis of the input image signal.

In more detail, the tone setter 104 periodically changes the drive tone value for the specific pixel, by using the tone value for at least one peripheral pixel (partial peripheral pixel) that is part of multiple peripheral pixels each of which is the above-mentioned peripheral pixel and whose number is greater than that of the specific pixel and the tone value set on the basis of the input image signal. The multiple peripheral pixels are hereinafter collectively referred to as “a peripheral pixel group”, and the at least one peripheral pixel as the partial peripheral pixel is hereinafter referred to as “a selected peripheral pixel”. Furthermore, the tone setter 104 cyclically changes the tone value for the selected peripheral pixel by using the tone values for the peripheral pixel group. The peripheral pixel group includes a pixel adjacent in at least any one of upper, lower, right, left and oblique directions to the specific pixel.

FIG. 3 shows a tone value shift table used to perform the periodical change of the drive tone value for the specific pixel and the cyclical change of the drive tone value for the selected peripheral pixel. The periodical change of the drive tone value for the specific pixel and the cyclical change of the drive tone value for the selected peripheral pixel are hereinafter collectively referred to as “a tone value shift”.

The tone setter 104 has a field counter that counts up its count value from 0 to 7 with one image field period and then counts down the count value to 0 with the one image field period. The tone setter 104 refers to the tone value shift table at each count up and each count down to sequentially change the drive tone value for the specific pixel G(x, y) that is the target pixel of the image quality degradation reduction process, to the drive tone value for the selected peripheral pixel G(x+dx, y+dy) indicated in the tone value shift table. For example, when the count value of the field counter is 5, a drive tone value I(x, y) for the specific pixel G(x, y) is changed into a drive tone value I(x, y+1) for the selected peripheral pixel G(x, y+1). The tone value shift table shown in FIG. 3 is merely an example, and other tone value shift tables may be used.

FIG. 4 shows an example of the tone value shift in the image quality degradation reduction process performed by the tone setter 104 by using the tone value shift table shown in FIG. 3. In FIG. 4, reference numeral 401 denotes a partial pixel area of the liquid crystal panel 108, and reference numeral P11 to P16, P21 to P26, P31 to P36, P41 to P46 and P51 to P56 denote drive tone values for respective pixels included in the partial pixel area. Furthermore, reference characters A and B denote original drive tone values for the specific pixels, which are the target pixels of the image quality degradation reduction process; the original drive tone value for each specific pixel is set so as to correspond to the input tone value. FIG. 4 shows a case where the adjacent two pixels are the specific pixels and their drive tone values are periodically changed. However, the specific pixel may be one of the adjacent two pixels. This applies to Embodiment 2 described later.

In the following description, the count values of the field counter from 0 to 7 are hereinafter simply referred to as “field counter 0” to “field counter 7”, and the drive tone value for the specific pixel is referred to as “a specific pixel drive tone value”.

Reference numeral 402 denotes an arrangement of the drive tone values for the respective pixels when the tone value shift corresponding to the field counter 0 is performed. The specific pixel drive tone values A and B are respectively rewritten to the drive tone values P22 and P23 for adjacent two pixels as the selected peripheral pixels located left above the specific pixels.

Reference numeral 403 denotes an arrangement of the drive tone values for the respective pixels when the tone value shift corresponding to the field counter 1 is performed. The specific pixel drive tone values A and B are respectively rewritten to the drive tone values P23 and P24 for adjacent two pixels as the selected peripheral pixels located above the specific pixels.

Reference numeral 404 denotes an arrangement of the drive tone values for the respective pixels when the tone value shift corresponding to the field counter 2 is performed. The specific pixel drive tone values A and B are respectively rewritten to the drive tone values P24 and P25 for adjacent two pixels as the selected peripheral pixels located right above the specific pixels.

Reference numeral 405 denotes an arrangement of the drive tone values for the respective pixels when the tone value shift corresponding to the field counter 3 is performed. The specific pixel drive tone values A and B are respectively rewritten to the drive tone values B and P35 for adjacent two pixels as the selected peripheral pixels located right the specific pixels.

Reference numeral 406 denotes an arrangement of the drive tone values for the respective pixels when the tone value shift corresponding to the field counter 4 is performed. The specific pixel drive tone values A and B are respectively rewritten to the drive tone values P44 and P45 for adjacent two pixels as the selected peripheral pixels located right below the specific pixels.

Reference numeral 407 denotes an arrangement of the drive tone values for the respective pixels when the tone value shift corresponding to the field counter 5 is performed. The specific pixel drive tone values A and B are respectively rewritten to the drive tone values P43 and P44 for adjacent two pixels as the selected peripheral pixels located below the specific pixels.

Reference numeral 408 denotes an arrangement of the drive tone values for the respective pixels when the tone value shift corresponding to the field counter 6 is performed. The specific pixel drive tone values A and B are respectively rewritten to the drive tone values P42 and P43 for adjacent two pixels as the selected peripheral pixels located left below the specific pixels.

Reference numeral 409 denotes an arrangement of the drive tone values for the respective pixels when the tone value shift corresponding to the field counter 7 is performed. The specific pixel drive tone values A and B are respectively rewritten to the drive tone values P32 and A for adjacent two pixels as the selected peripheral pixels located left the specific pixels.

As described above, this embodiment periodically changes the drive tone value for the specific pixel by using the drive tone value for the selected peripheral pixel among the peripheral pixel group. In other words, this embodiment replaces the drive tone value for the specific pixel by the drive tone value for the selected peripheral pixel. Thus, this embodiment reduces the image quality degradation generated in the specific pixel due to the disclination, thereby making the image quality degradation unnoticeable.

Even when the disclination estimation process is performed by using the liquid crystal panel for G, it is desirable to perform the image quality degradation reduction process for the specific pixel (in which the estimation that the disclination is generated is made) on the three liquid crystal panels for RGB. Furthermore, even when the disclination estimation process is performed by using the three liquid crystal panels for RGB and the estimation that the disclination is generated is made for only one liquid crystal panel, it is desirable to perform the image quality degradation reduction process on the three liquid crystal panels for RGB.

### Embodiment 2

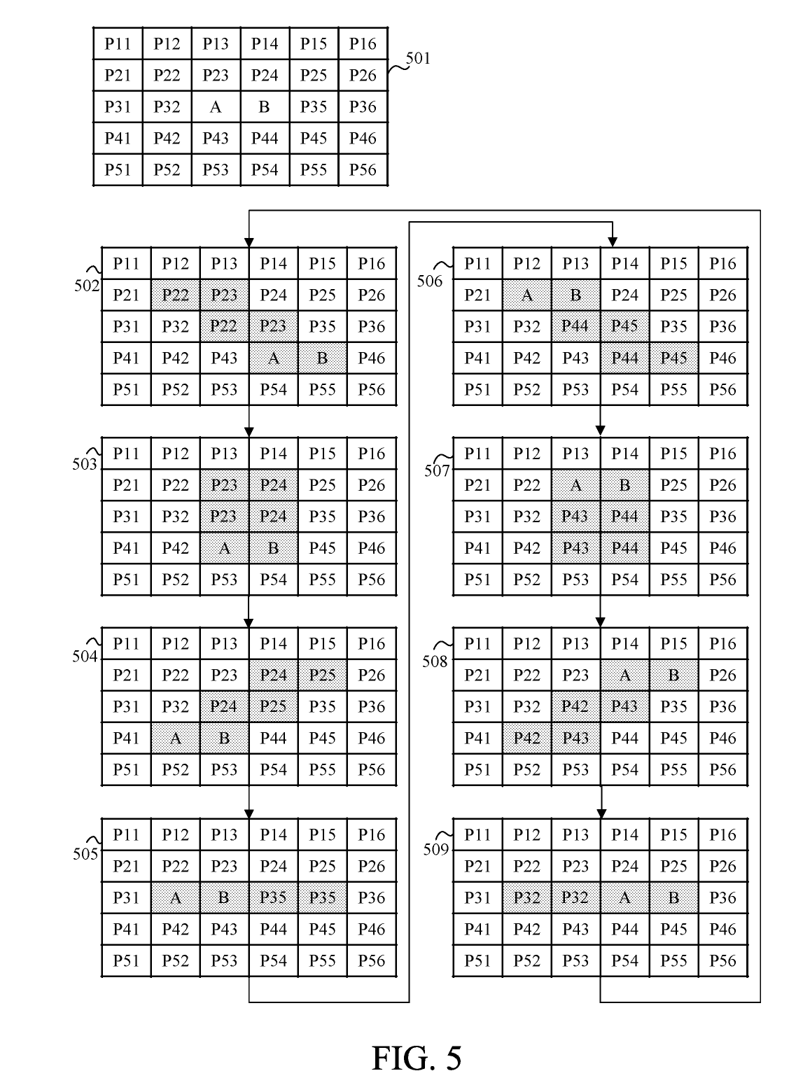

Next, description will be made of a second embodiment (Embodiment 2) of the present invention with reference to FIG. 5. A configuration of a projector and a disclination estimation process in this embodiment are the same as those in Embodiment 1. This embodiment is different from Embodiment 1 in the method of the tone value shift in the image quality degradation reduction process.

Specifically, this embodiment is common to Embodiment 1 in that the tone setter 104 periodically (sequentially) changes the drive tone value of the specific pixel G(x, y), depending on the field counter 0 to 7 shown in FIG. 3, to the drive tone value for the selected peripheral pixel G(x+dx, y+dy) indicated in the tone value shift table. However, in this embodiment, the tone setter 104 changes, with the change of the drive tone value of the specific pixel, drive tone values for peripheral pixels (x−dx, y−dy) other than the selected peripheral pixel to A and B.

Reference numeral 501 denotes a partial pixel area of the liquid crystal panel 108, and reference numeral P11 to P16, P21 to P26, P31 to P36, P41 to P46 and P51 to P56 denote drive tone values for respective pixels included in the partial pixel area. Reference characters A and B denote original drive tone values for the specific pixels, which are the target pixels of the image quality degradation reduction process; the original drive tone value for each specific pixel is set so as to correspond to the input tone value. FIG. 5 also shows a case where the adjacent two pixels are the specific pixels and their drive tone values are periodically changed.

Reference numeral 502 denotes an arrangement of the drive tone values for the respective pixels when the tone value shift corresponding to the field counter 0 is performed. The specific pixel drive tone values A and B are respectively rewritten to the drive tone values P22 and P23 for adjacent two pixels as the selected peripheral pixels located left above the specific pixels. Simultaneously, the drive tone values for, among the peripheral pixel groups, adjacent two pixels located right below the specific pixels are rewritten to A and B.

Reference numeral 503 denotes an arrangement of the drive tone values for the respective pixels when the tone value shift corresponding to the field counter 1 is performed. The specific pixel drive tone values A and B are respectively rewritten to the drive tone values P23 and P24 for adjacent two pixels as the selected peripheral pixels located above the specific pixels. Simultaneously, the drive tone values for, among the peripheral pixel groups, adjacent two pixels located below the specific pixels are rewritten to A and B.

Reference numeral 504 denotes an arrangement of the drive tone values for the respective pixels when the tone value shift corresponding to the field counter 2 is performed. The specific pixel drive tone values A and B are respectively rewritten to the drive tone values P24 and P25 for adjacent two pixels as the selected peripheral pixels located right above the specific pixels. Simultaneously, the drive tone values for, among the peripheral pixel groups, adjacent two pixels located left below the specific pixels are rewritten to A and B.

Reference numeral 505 denotes an arrangement of the drive tone values for the respective pixels when the tone value shift corresponding to the field counter 3 is performed. The specific pixel drive tone values A and B are respectively rewritten to the drive tone values B and P35 for adjacent two pixels as the selected peripheral pixels located right the specific pixels. Simultaneously, the drive tone value for, among the peripheral pixel groups, a pixel located left the left specific pixel whose drive tone value is B is rewritten to A.

Reference numeral 506 denotes an arrangement of the drive tone values for the respective pixels when the tone value shift corresponding to the field counter 4 is performed. The specific pixel drive tone values A and B are respectively rewritten to the drive tone values P44 and P45 for adjacent two pixels as the selected peripheral pixels located right below the specific pixels. Simultaneously, the drive tone values for, among the peripheral pixel groups, adjacent two pixels located left above the specific pixels are rewritten to A and B.

Reference numeral 507 denotes an arrangement of the drive tone values for the respective pixels when the tone value shift corresponding to the field counter 5 is performed. The specific pixel drive tone values A and B are respectively rewritten to the drive tone values P43 and P44 for adjacent two pixels as the selected peripheral pixels located below the specific pixels. Simultaneously, the drive tone values for, among the peripheral pixel groups, adjacent two pixels located above the specific pixels are rewritten to A and B.

Reference numeral 508 denotes an arrangement of the drive tone values for the respective pixels when the tone value shift corresponding to the field counter 6 is performed. The specific pixel drive tone values A and B are respectively rewritten to the drive tone values P42 and P43 for adjacent two pixels as the selected peripheral pixels located left below the specific pixels. Simultaneously, the drive tone values for, among the peripheral pixel groups, adjacent two pixels located right above the specific pixels are rewritten to A and B.

Reference numeral 509 denotes an arrangement of the drive tone values for the respective pixels when the tone value shift corresponding to the field counter 7 is performed. The specific pixel drive tone values A and B are respectively rewritten to the drive tone values P32 and A for adjacent two pixels as the selected peripheral pixels located left the specific pixels. Simultaneously, the drive tone value for, among the peripheral pixel groups, a pixel located right the right specific pixel whose drive tone value is A is rewritten to B.

As described above, this embodiment also periodically changes the drive tone value for the specific pixel by using the drive tone value for the selected peripheral pixel among the peripheral pixel group, as in Embodiment 1. In other words, this embodiment replaces the drive tone value for the specific pixel by the drive tone value for the selected peripheral pixel. Thus, this embodiment reduces the image quality degradation generated in the specific pixel due to the disclination, thereby making the image quality degradation unnoticeable. Furthermore, this embodiment replaces the drive tone value for the peripheral pixel other than the selected peripheral pixel by the original drive tone value for the specific pixel. Providing such an original drive tone value for the specific pixel as that for the peripheral pixel enables reducing the image quality degradation due to the disclination while making a projected image closer to an original tone image.

Embodiments 1 and 2 described the case where the drive tone value for the specific pixel is replaced directly by the drive tone value for the peripheral pixel set corresponding to the input tone value. However, the drive tone value for the specific pixel may be replaced by a tone value obtained by performing a predetermined process (such as a calculation) on the drive tone value for the peripheral pixel set corresponding to the input tone value. That is, changing the drive tone value for the specific pixel by using the drive tone value for the peripheral pixel is not limited to replacing the drive tone value for the specific pixel directly by the drive tone value for the peripheral pixel. For example, an average value of the drive tone values for the multiple peripheral pixels may be used as the drive tone value for the specific pixel. In addition, since the image quality degradation reduction process in each of Embodiments 1 and 2 is equivalent to a spatial low-pass filter process, a tone value calculated by a calculation equivalent to a high-pass filter process from the drive tone value for the peripheral pixel may be used as the drive tone value for the specific pixel.

### Embodiment 3

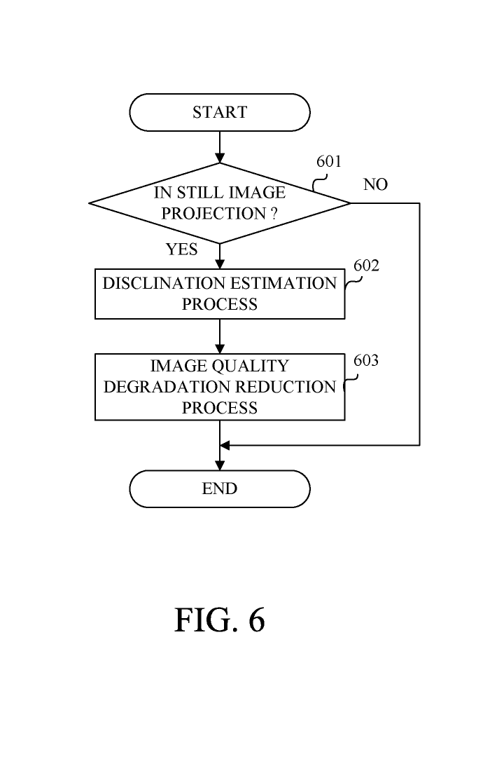

Next, description will be made of a third embodiment (Embodiment 3) of the present invention. FIG. 6 is a flowchart of a liquid crystal drive process performed in this embodiment. A configuration of a projector, a disclination estimation process and an image quality degradation reduction process performed in this embodiment are the same as those in Embodiments 1 and 2. This embodiment is different from Embodiments 1 and 2 in that a determination is made of whether or not the input image signal is a still image signal for displaying a still image before the disclination estimation process and the image quality degradation reduction process.

At step 601, an image determiner (the disclination estimator 103 or the tone setter 104 shown in FIG. 1) determines whether or not the input image signal 101 is the still image signal, that is, whether or not the projector 100 is currently projecting a still image. Specifically, the image determiner determines whether or not multiple feature points extracted from continuous subfields (or frames) in the input image signal 101 do not move, or whether or not a change in a histogram is within a predetermined small range. However, the determination of whether or not the input image signal 101 is the still image signal may be made by any determination method.

If a determination that the input image signal 101 is not the still image signal (that is, the input image signal 101 is a moving image signal for displaying a moving image), the disclination estimator 103 and the tone setter 104 do not perform (that is, restrict performing) the disclination estimation process and the image quality degradation reduction process, respectively. On the other hand, if a determination that the input image signal 101 is the still image signal, the disclination estimator 103 and the tone setter 104 respectively perform at steps 602 and 603 the disclination estimation process and the image quality degradation reduction process.

This embodiment performs the image quality degradation reduction process on the still image signal, but does not perform this process on the moving image signal. This is because the image quality degradation due to the disclination is not noticeable in displaying a moving image, and because the image quality degradation reduction process is basically equivalent to a spatial low-pass filer process, which may slightly degrade image quality of the moving image.

Each of the above-described embodiments reduces the image quality degradation due to the disclination generated in the specific pixel, which enables displaying a good quality image.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-031216, filed on Feb. 20, 2015, which is hereby incorporated by reference wherein in its entirety.

What is claimed is:

1. A liquid crystal drive apparatus configured to drive a liquid crystal display element, the apparatus comprising:
a tone setter configured to set a tone value for each pixel of the liquid crystal display element on a basis of an input image signal; and
a disclination determiner configured to determine, by using the tone value for a specific pixel of the liquid crystal display element set on the basis of the input image signal, whether disclination is generated in the specific pixel,
wherein the tone setter is configured to, when a determination that the disclination is generated is made, periodically change the tone value for the specific pixel, by using a tone value for a peripheral pixel located in a periphery of the specific pixel and the tone value set on the basis of the input image signal.

2. A liquid crystal drive apparatus according to claim 1, wherein the tone setter is configured to, when the determination that the disclination is generated is made,
(a) periodically change the tone value for the specific pixel, by using:
a tone value for a partial peripheral pixel among multiple peripheral pixels each of which is the peripheral pixel and whose number is greater than that of the specific pixel; and
the tone value set on the basis of the input image signal, and
(b) cyclically change the tone value for the partial peripheral pixel by using the tone values for the multiple peripheral pixels.

3. A liquid Crystal drive apparatus according to claim 1, wherein the disclination determiner determines that the disclination is generated when one of the tone vales for the specific pixel and an adjacent pixel adjacent to the specific pixel, each of which are set on the basis of the input image signal, is within a first predetermined range and another one thereof is within a second predetermined range.

4. A liquid Crystal drive apparatus according to claim 1, further comprising:
an image determiner configured to determine whether the input image signal is a still image signal for displaying a still image,
wherein the tone setter is configured to change the tone value of the specific pixel when a determination that the input image signal is the still image signal is made.

5. A liquid crystal display apparatus comprising:
a liquid crystal display element; and
a liquid crystal drive apparatus configured to drive the liquid crystal display element, the liquid crystal drive apparatus comprising:
a tone setter configured to set a tone value for each pixel of the liquid crystal display element on a basis of an input image signal; and
a disclination determiner configured to determine, by using the tone value for a specific pixel of the liquid crystal display element set on the basis of the input image signal, whether disclination is generated in the specific pixel,
wherein the tone setter is configured to, when a determination that the disclination is generated is made, periodically change the tone value for the specific pixel, by using a tone value for a peripheral pixel located in a periphery of the specific pixel and the tone value set on the basis of the input image signal.

6. A non-transitory computer-readable storage medium storing a liquid crystal drive program as a computer program to cause a computer to execute a process, the process comprising:
setting a tone value for each pixel of a liquid crystal display element on a basis of an input image signal;
determining, by using the tone value for a specific pixel of the liquid crystal display element set on the basis of the input image signal, whether disclination is generated in the specific pixel,
wherein, when a determination that the disclination is generated is made, the process periodically changes the tone value for the specific pixel, by using a tone value for a peripheral pixel located in a periphery of the specific pixel and the tone value set on the basis of the input image signal.
